(19) United States
(12) Patent Application Publication
(10) Pub. No.: US 2007/0173747 A1
(43) Pub. Date: Jul. 26, 2007

(54) Joint stimulator

(76) Inventor: Jesse A. Knotts, Fort Wayne, IN (US)

Correspondence Address: TAYLOR & AUST, P.C., 142 SOUTH MAIN STREET, P. O. BOX 560, AVILLA, IN, 46710, US

(21) Appl. No.: 11/337,989

(22) Filed: Jan. 24, 2006

(51) Int. Cl. A61H 1/00

(52) U.S. Cl. 601/5; 601/23; 601/26; 601/33

(57) ABSTRACT

A human extremity movement system including a work surface, a repetitive movement apparatus connected to the work surface, a roll and a releasable constraint. The roll rotatably connected to said repetitive movement apparatus. The releasable constraint being releasably connected to the roll. The releasable constraint enveloping at least a portion of the extremity with a portion of the extremity being supported by the work surface.

### BACKGROUND OF THE INVENTION

1. Field of the Invention

The present invention relates to a human joint stimulator device, and, more particularly, to a repetitive human joint stimulator and extremity movement device.

2. Description of the Related Art

Various medical conditions result in the loss, or reduction of use of an extremity, such as arthritis or a stoke. For example, a stroke may result in a loss or degradation of use and control of a portion of the body. One result of a stroke is the loss of use of one side of a person's body, which is caused by a blood flow restriction or clot in the brain. The extremity, through lack of use, can atrophy resulting in reduced muscle mass. Another result of non-use of an extremity can be reduced range of movement particularly, in the hands. This can result in reduced dexterity and/or range of movement by the individual that is recovering from a stroke and can become a permanent condition.

Repetitive motion mechanisms exist that move joints such as knee joints after knee replacement surgery so that leg motion can be restored to a normal level following surgery.

What is needed in the art is an economical hand or arm movement device.

### SUMMARY OF THE INVENTION

The present invention relates to a human joint stimulator and extremity movement device, particularly for the movement of the joints of a hand.

The invention comprises, in one form thereof, a human extremity movement system including a work surface, a repetitive movement apparatus connected to the work surface, a roll and a releasable constraint. The roll rotatably connected to said repetitive movement apparatus. The releasable constraint being releasably connected to the roll. The releasable constraint enveloping at least a portion of the extremity with a portion of the extremity being supported by the work surface.

An advantage of the present invention is that glove is releasably connected to a rotating member that allows the fingers to rotate therearound and yet be releasable therefrom.

Another advantage of the present invention is that the repetition rates, duration at hold time and distance of movement are all adjustable.

Another advantage of the present invention is that the hand is easily releasable from the movement apparatus in the event the patient desires to be released therefrom.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of one embodiment of a human extremity movement device of the present invention;

FIG. 2 is a top view of the movement device of FIG. 1;

FIG. 3 is another top view of the movement device of FIGS. 1 and 2;

FIG. 4 is a partially sectioned side view of a portion of the movement device of FIGS. 1-3;

FIG. 5 is another partially sectioned side view of the movement device of FIGS. 1-4;

FIG. 6 is another embodiment of the human extremity movement device of the present invention;

FIG. 7 is a partially sectioned side view of the movement device of FIG. 6;

FIG. 8 is another partially sectioned side view of the movement device of FIGS. 6 and 7;

FIG. 9 is a side view of another embodiment of the human extremity movement device of the present invention; and

FIG. 10 is a side view of yet another embodiment of the present invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

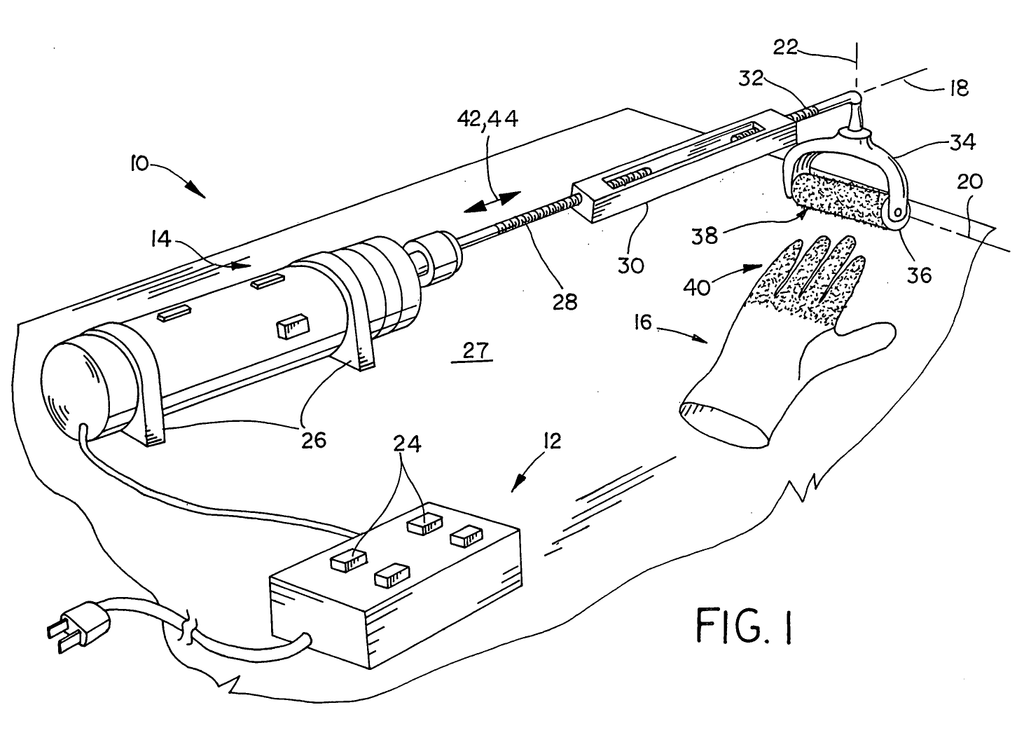

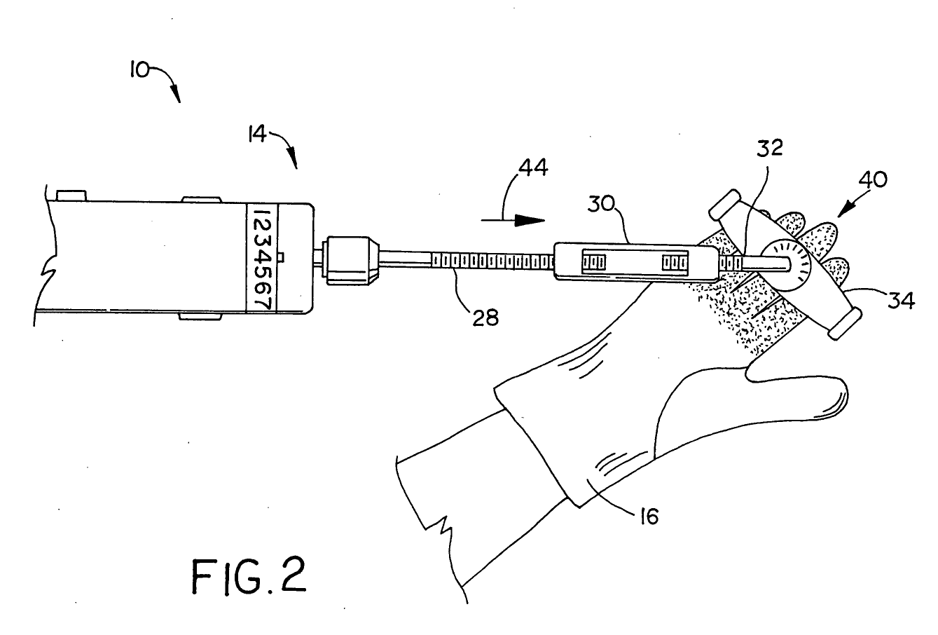

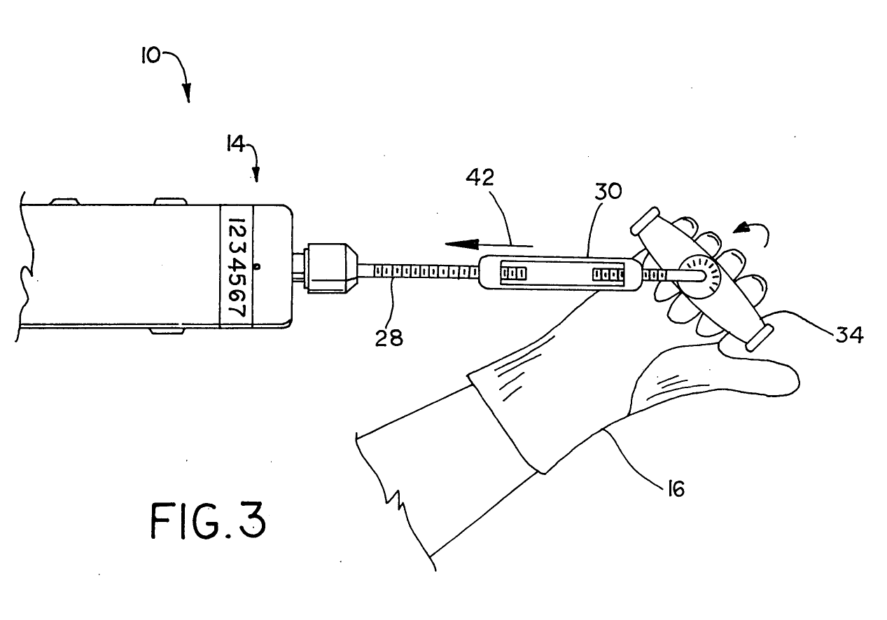

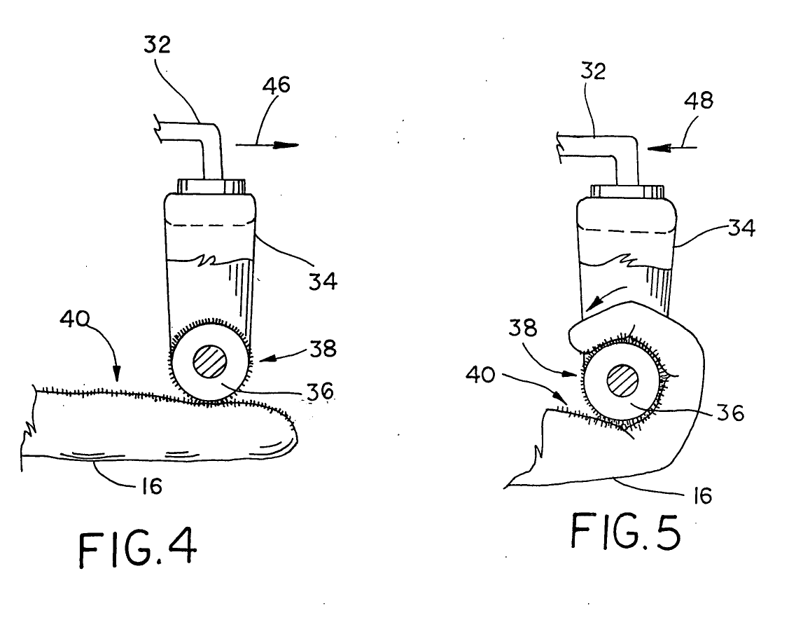

Referring now to the drawings, and more particularly to FIGS. 1-5, there is shown a human extremity movement device 10 including a controller 12, a driver 14 and a glove 16. Driver 14 rotates about an axis 18 causing a portion of driver 14 to move causing rotation about axis 20 and axis 22 during use. Driver 14 includes torque selections that act as a clutching arrangement. If a resistance to movement is encountered driver 14 will cease rotation about axis 18, dependant upon the selected torque.

Controller 12 includes control selections 24 which govern the movements of driver 14. Controller selections 24 include the selection and variation of speed profiles, acceleration, repeatable directions of rotation, number of repetitions until an automatic stop, distance of movement and hold times at positional extremes. Control selections 24 may alternatively be controlled by another automated process such as a computer system, not shown.

Driver 14 is connected by mount 26 to a work surface 27, such as a table, which may include padding or other features to accommodate a patient's extremity. Driver 14 includes a threaded shaft 28, a positional adjustment 30, a threaded stirrup rod 32, a stirrup 34 and a roll 36. Threaded shaft 28 is driven in a rotatable manner by driver 14 and the threads thereon rotate in positional adjustment 30 causing lateral movement of stirrup 34. The combination of threaded stirrup rod 32 and positional adjustment 30 can be used to provide an initial position, by rotating positional adjustment 30 relative to stirrup rod 32 until a desired position, which may be thought of as a start position of stirrup 34, is achieved. Alternatively, stirrup rod 32 may be fixed to positional adjustment 30. Threaded stirrup rod 32 is threadably connected to positional adjustment 30 and is rotatably connected to stirrup 34 so that stirrup 34 may rotate about axis 22. Stirrup 34 has a roll 36 that is rotatably connected to stirrup 34. Roll 36 rotates about axis 20 in a generally unrestrained manner. Roll 36 has a releasable hook/loop arrangement 38 thereon that interacts with a complimentary releasable hook/loop structure 40 on glove 16. Releasable hook/loop structures 38 and 40 interact to allow glove 40 to be variously connected to and rotated about roll 36 as stirrup 34 moves in a lateral direction.

Once controller 12 is set up in a desired mode by the selecting of the speed, acceleration, direction, number of repetitions, hold time durations and distances of movement, then the patient inserts their hand into glove 16 and a portion of glove 16 is placed in contact with roll 36. Releasable hook/loop arrangements 38 and 40 interact to connect a portion of glove 16 to roll 36. Controller 12 is then initiated causing a rotational movement on threaded rod 28, which causes the movement of positional adjustment 30 in a direction 42 and conversely in a direction 44. The lateral movement of positional adjustment 30 causes threaded stirrup rod 32 and stirrup 34 to likewise move in directions 42 and 44. As positional adjustment 30 moves in direction 44 the patients hand rotates about roll 36 increasing the amount of contact between roll 36 and glove 16. While roll 36 is shown as a cylindrical roll, different diameters of cylindrical rolls and profile diameters are also contemplated. A profiled roll 36 could have different diameters along the lateral direction of roll 36 thereby allowing the fingers of the patient to be rotated to different extremes based on the lateral movement of positional adjustment 30. As stirrup 34 moves in directions 36 and 38, in a repetitive manner, the patient's joints are exercised helping to also prevent the atrophy of the muscle tissue, the stretching of tendons and exercising the patient's hand. Although releasable hook and loop arrangements 38 and 40 are shown to extend over a considerable amount of the surface of glove 16 and around the entire outer surface of roll 36, it should be understood that a lesser amount of hook/loop arrangements 38 and 40 are also contemplated.

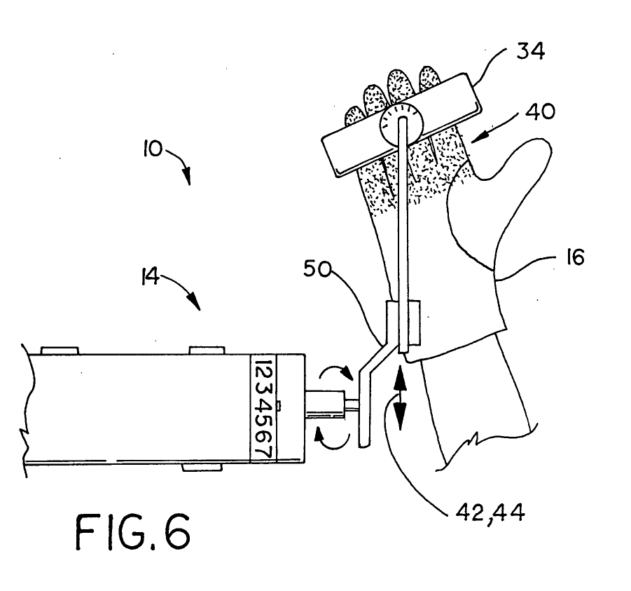

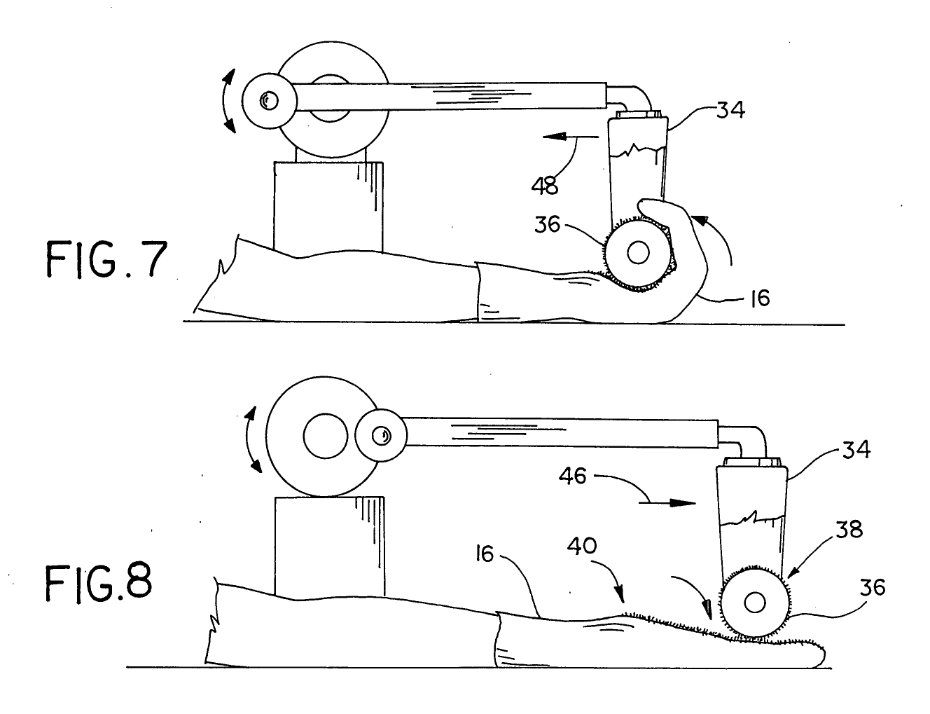

Now, additionally referring to FIGS. 6-8 there is shown another embodiment of human extremity movement device 10 having an offset arm 50, which rotates in a quasi lateral movement causing stirrup 34 to move in directions 46 and 48. The interaction of glove 16 with roll 36 and stirrup 34 is similar to that discussed in the first embodiment above.

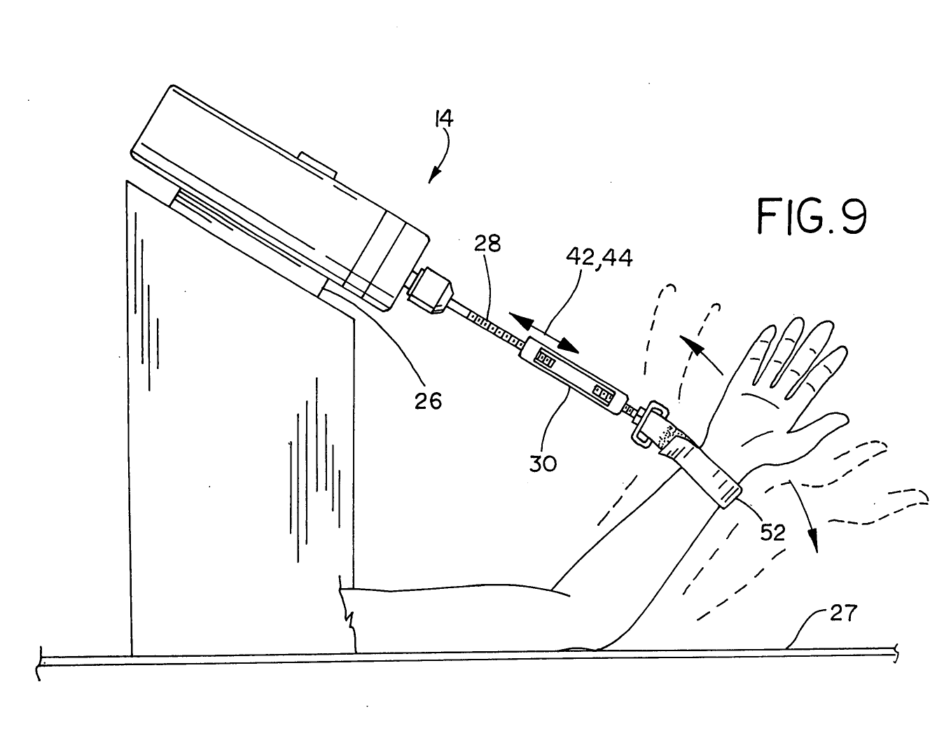

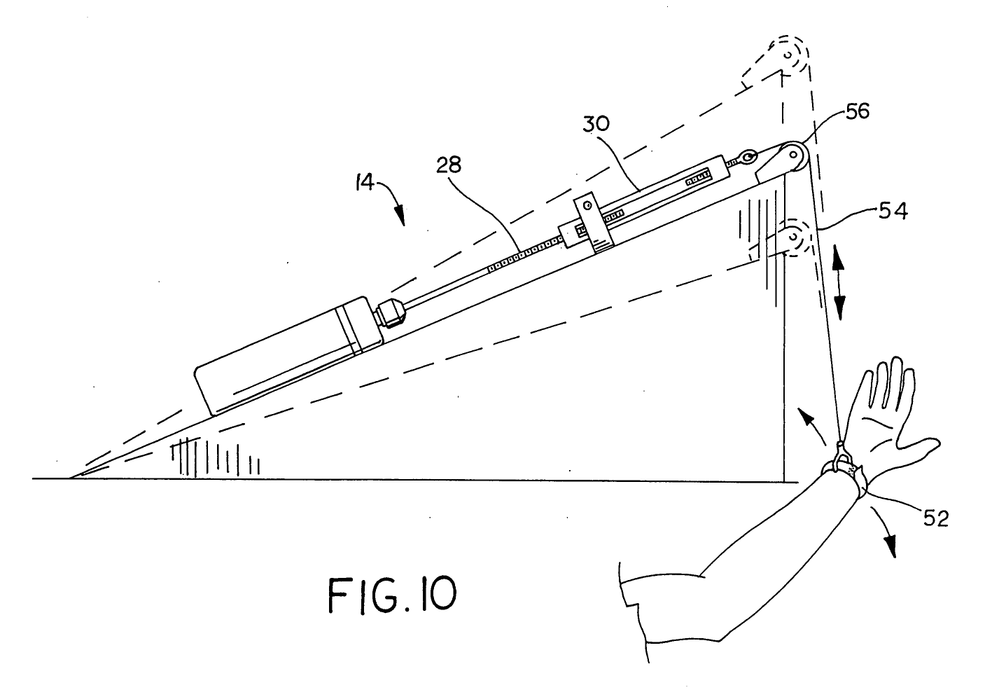

Now, additionally referring to FIG. 9 there is shown another embodiment of the present invention illustrating the replacement of stirrup 34 with a strap 52 that is connected to the arm of a patient. The control of driver 14 is identical to that discussed above. Additionally referring to FIG. 10 there is shown yet another embodiment of a driver 14 moving a human extremity in another manner involving a cable 54 that is connected to driver 14 and travels over a pulley 56. The patients arm is repetitively lifted in a swinging manner from cable 54.

The present invention advantageously connects a glove, or other releasable constraint, to a moving rotatable roll 36 and allows the patient to easily remove their hand from the mechanism.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A human extremity movement system, comprising:
a work surface;
a repetitive movement apparatus connected to said work surface;
a roll rotatably connected to said repetitive movement apparatus; and
a releasable constraint releasably connected to said roll, said releasable constraint enveloping at least a portion of the extremity, another portion of the extremity being supported by said work surface.

2. The system of claim 1, wherein said repetitive movement apparatus is adjustable in at least one of speed, acceleration, direction, number of repetitions, hold time in extreme positions and distance of movement.

3. The system of claim 1, wherein said releasable constraint additionally includes a glove having at least one finger that is in contact with the roll.

4. The system of claim 3, wherein said glove is movable about a portion of said roll as said repetitive movement apparatus causes said roll to move.

5. The system of claim 4, wherein said releasable constraint includes one of a hook arrangement and a loop arrangement, said roll including one of a hook arrangement and a loop arrangement.

6. The system of claim 1, wherein said roll is rotatably about a first axis said repetitive movement apparatus includes a rotary drive rotating a shaft about a second axis.

7. The system of claim 6, wherein said repetitive movement apparatus includes a stirrup rotatably attached thereto about a third axis, said roll being rotatably connected to said stirrup.

8. A human extremity movement device, comprising:
a repetitive movement apparatus;
a roll rotatably connected to said repetitive movement apparatus; and
a releasable constraint releasably connected to said roll, said releasable constraint enveloping at least a portion of the extremity.

9. The device of claim 8, wherein said repetitive movement apparatus is adjustable in at least one of speed, acceleration, direction, number of repetitions, hold time in extreme positions and distance of movement.

10. The device of claim 8, wherein said releasable constraint additionally includes a glove having at least one finger that is in contact with the roll.

11. The device of claim 10, wherein said glove is movable about a portion of said roll as said repetitive movement apparatus causes said roll to move.

12. The device of claim 11, wherein said releasable constraint includes one of a hook arrangement and a loop arrangement, said roll including one of a hook arrangement and a loop arrangement.

13. The device of claim 8, wherein said roll is rotatable about a first axis, said repetitive movement apparatus including a rotary drive rotating a shaft about a second axis.

14. The device of claim 13, wherein said repetitive movement apparatus includes a stirrup rotatably attached thereto about a third axis, said roll being rotatably connected to said stirrup.

15. A method of moving a hand, comprising the steps of:
inserting the hand into a removable constraint;
detachably attaching said removable constraint to a roll that is rotatable about a first axis; and
rotating a shaft about a second axis causing said roll to move in a linear direction and said roll to rotate about said first axis.

16. The method of claim 15, wherein said roll rotates about said first axis by way of interaction of said removable constraint with said roll as said shaft rotates.

17. The method of claim 15, wherein said removable constraint one of increases and decreases attachment with said roll as said roll rotates about said first axis.

18. The method of claim 15, wherein said roll is held by a stirrup that is moved in said linear direction, said stirrup being rotatable about a third axis.
